(19) United States
(12) Patent Application Publication
(10) Pub. No.: US 2006/0017715 A1
(43) Pub. Date: Jan. 26, 2006

(54) Display device, display driver, and data transfer method

(75) Inventors: Tohru Kimura, Izumi (JP); Hideaki Watanabe, Izumi (JP)

Correspondence Address: DRINKER BIDDLE & REATH (DC), 1500 K STREET, N.W., SUITE 1100, WASHINGTON, DC, 20005-1209, US

(73) Assignee: PIONEER PLASM DISPLAY CORPORATION

(21) Appl. No.: 11/101,628

(22) Filed: Apr. 8, 2005

(30) Foreign Application Priority Data
Apr. 14, 2004 (JP) 2004-118731

(51) Int. Cl. G09G 5/00

(52) U.S. Cl. 345/204

(57) ABSTRACT

A display device includes a display unit and a plurality of display drivers. Each of the display drivers has a digital operation unit and a drive unit. The digital operation unit of each display driver has a signal determination unit for determining whether or not a destination of an input signal is a display driver which is currently receiving the input signal, based on an ID signal contained in the input signal. The display driver fetches a display data signal contained in the input signal if the signal determination unit determines that the destination of the input signal is the display driver concerned.

### BACKGROUND OF THE INVENTION

1. Field of the Invention

The present invention relates to a display device, a display driver, and a data transfer method.

2. Description of the Related Art

Data driver IC are used in industrial fields of flat displays. Video signals processed by using ultra-large-scale integration circuits are supplied to such data driver IC. The data driver IC are configured to convert the input video signals into signals for driving a display panel.

An example of a data driver for a color plasma display panel (PDP) used in a color PDP module is described in a document titled “MOS Integrated Circuit μPD16373, 256/192 Bit Switching, AC-PDP driver, NEC Corporation., March, 2001.”

Referring to FIG. 7 of the accompanying drawings, the configuration of a conventional wide XGA (W-XGA; 1365×768 pixels) color PDP module 4 that uses the data driver described in the above-mentioned document titled “MOS Integrated Circuit μPD16373, 256/192 Bit Switching, AC-PDP driver, NEC Corporation., March, 2001,” is now described. This data driver has a 256-bit output and 4-phase input.

As shown in FIG. 7, the conventional color PDP module 4 receives an input video signal 5 from outside, and applies video signal processing operations on the input video signal 5 using a low-voltage signal with a voltage of 3.3 V or less in an ultra-large-scale integration circuit on a digital signal processing board 1. Then, the signals are sent to a data driver 2 after raising the signal voltage to 5.0 V at the output stage of the digital signal processing board 1, in order to drive a PDP 50.

The data driver 2 simultaneously outputs the data of one line (1365 pixels) to the plasma display panel. For this purpose, the W-XGA display panel requires sixteen (1365×3 [1 pixel for each RGB]/256=<16) 256-bit output data drivers 2.

Each data driver 2 has six signal lines: four lines for video input signals (Data), one line for clock input signal (CLK), and one line for latch enable input signal (LE). Therefore, the number of signal lines 3 extending from the digital signal processing board 1 to the data driver 2 becomes 96 (6×16=96).

The data driver 2 includes a register, a level conversion circuit for voltage conversion (amplification) and a high-voltage output buffer.

A video data signal transferred from the digital signal processing board 1 in synchronization with a transfer clock signal is introduced in the data driver 2. The video data signal is stored in the register of the data driver 2 and sent to the level conversion circuit in synchronization with the input of the latch enable signal.

All the signals supplied into the data driver 2 have an amplitude of 5.0 V. In the data driver 2, the section (including the register) up to the input to the level conversion circuit is a low-voltage operation unit 21. In the low-voltage operation unit 21, processing is conducted at an amplitude of 5.0 V. The level conversion circuit is a voltage conversion unit 22, and the signal with an amplitude of 5.0 V is amplified to an amplitude of 70 V. In the data driver 2, the section including and following the level conversion circuit (including the high-voltage output buffer) is a high-voltage operation unit 23. The high-voltage signal generated from the level conversion circuit is supplied to the PDP via the high-voltage output buffer.

The following problems are associated with the above-described data transfer method.

The first problem is that the phase difference between a total of 96 video data signals, clock signals, and latch enable signals cannot be stored.

For example, if the phase of the video data signal is different from the phase of the clock signal, the video signal set in the register of the data driver 2 becomes one signal before or one signal after the intended signal. In this case, the display position of the pixels is shifted and abnormal image is displayed. This problem rises because of the necessity to transfer a large number of high-speed signals over a long distance.

In order to explain this problem, a color PDP with a scanning period of 1 μs (microsecond) will be described below.

A fact that a scanning period of a color PDP is 1 μs means that the interval in which a data driver outputs a video signal of one line to the plasma display panel is 1 μs. Video data of the first line are sent to the plasma display panel, then after 1 μs, the video data of the second line is sent to the plasma display panel, and then after 1 μs, the video data of the third line is sent to the plasma display panel. The data driver updates the data every 1 μs. For example, a 256-bit, 4-layer input data driver requires 64 transfer clocks to fetch the data of one line (this is because 256/4=64). In order to fetch data of 64 clocks within an interval of 1 μs, the interval of 1 clock has to be 15.6 ns (nanosecond) or less, and a clock frequency has to be 64 MHz.

A plasma display panel is a flat panel with a large surface area, and 50-inch display panels have a width of about 1 m 20 cm and a height of about 70 cm. Therefore, a total of 96 high-speed signals have to be sent with a phase difference of a nanosecond order to data drivers with a wiring length difference of about 1 m. This is very difficult to implement with the present semiconductor technology.

Also, the interfaces between the digital board data drivers is the main cause of a high cost and a small reliability margin.

Thus, a large number of pins of the signal processing LSI on the digital signal processing board 1, a large number of signal output buffers on the digital signal processing board 1, and a large number of wiring from the digital signal processing board 1 to the data drivers 2 are required (89 wiring for a W-XGA module) and the cost is high. The system has a large surface area, high power consumption, and a wide operation temperature range, so that noise penetration occurs from the high-voltage operation unit via a power source and GND and skew occurs between the data signals and between the data signal and clock signal due to a multipin configuration. Consequently, it is in principle difficult to guarantee the setup/hold in the data driver input unit, and ensure a satisfactory operation reliability margin.

The second problem is that signals are not correctly introduced into a low-voltage input unit. Like the first problem, the unintended signals are supplied into the data driver 2, thereby producing a display video abnormality. This problem rises due to the occurrence of a bounce at a power source potential and ground potential when a large current flows in a high-voltage operation unit. The operation voltage of the high-voltage operation unit is 70 V, and the operation voltage of the low-voltage operation unit is 5.0 V. There is only one ground potential in a color PDP module. If the ground potential bounces at about 2 V as the high-voltage operation unit operates, the input threshold of the low-voltage operation unit fluctuates through 2 V and becomes close to a logical threshold (2.5 V). As a result, the input signal with a high potential to low potential ratio (H/L) with a signal amplitude of only 5 V is not appropriately fetched to the register.

### SUMMARY OF THE INVENTION

One object of the present invention is to provide a display device that enables highly reliable and low-cost signal input.

Another object of the present invention is to provide a display driver that enables highly reliable and low-cost signal input.

Still another object of the present invention is to provide a data transfer method that enables highly reliable and low-cost signal input.

According to one aspect of the present invention, there is provided a display device that includes a display unit and a plurality of display drivers. Each display driver has a digital operation unit and a drive unit. Each digital operation unit has a signal determination unit for determining whether or not the destination of an input signal is the display driver having this digital operation unit based on a determination signal contained in the input signal.

Each digital operation unit may further include a synchronization unit for conducting synchronization with a clock signal or the determination signal contained in the input signal.

Preferably, the input signal contains a display data signal. Preferably, when the signal determination unit determines that the destination of the input signal is the display driver which is currently receiving the input signal, the display driver concerned fetches the display data signal contained in the input signal.

It is preferred that the display data signal be a coded data signal and that each digital operation unit further have a decoder unit for decoding the display data signal.

The display driver may fetch an input signal if the signal determination unit determines that the destination of the input signal is the display driver concerned.

The digital operation unit may have an initialization setting unit for performing initialization setting of the display unit when an initialization signal contained in the input signal is detected.

According to a second aspect of the present invention, there is provided another display device that includes a display unit and a plurality of display drivers. Each display driver has a digital operation unit and a drive unit. Each digital operation unit analyzes a control signal contained in the input signal and controls the associated drive unit in accordance with analysis results of the control signal.

It is preferred that the control signal include a determination signal and that the digital operation unit determine whether or not the destination (input object) of the input signal carrying the determination signal is a display driver having this digital operation unit, in accordance with the analysis results of the determination signal.

Preferably, the control signal contains a synchronization signal, and the digital operation unit analyzes the synchronization signal and conducts synchronization with the synchronization signal.

The control signal may include a coded display data signal and the digital operation unit may control the associated drive unit in accordance with the analysis results of the display data signal.

The control signal may include an initialization signal and the digital operation unit may conduct initialization setting of the display unit in accordance with the analysis results of the initialization signal.

It is preferred that the display drivers be connected in series with each other and that the input signal be serially transferred from a leading display driver.

Alternatively, the display drivers may be connected in parallel with each other and the input signal may be introduced into each display driver.

The input signal may be a complementary signal.

According to a third aspect of the present invention, there is provided a display driver that includes a digital operation unit and a drive unit to drive a display panel with the drive unit in accordance with an input signal. The digital operation unit includes a signal determination unit for determining whether or not the destination of the input signal is the display driver based on a determination signal contained in the input signal.

According to a fourth aspect of the present invention, there is provided a data transfer method for transferring data to a semiconductor device. The semiconductor device includes a digital operation unit and a drive unit. The data transfer method includes the step of supplying to the digital operation unit an input signal carrying a determination signal used for determining whether or not the destination of the input signal is the semiconductor device concerned, and the step of supplying a signal generated from the digital operation unit into the associated drive unit.

According to a fifth aspect of the present invention, there is provided another data transfer method for transferring data to a semiconductor device. The semiconductor device has a digital operation unit and a drive unit to drive a display panel with the drive unit in accordance with an input signal. The data transfer method includes the step of supplying to the digital operation unit the input signal which contains a determination signal used for determining whether or not the destination of the input signal is the semiconductor device concerned. The data transfer method also includes the step of supplying display data to be displayed on the display panel into the digital operation unit.

The data transfer method may further include the step of supplying to the digital operation unit a fetch timing signal specifying the timing for the digital operation unit to fetch the display data.

The input signal introduced into the digital operation unit is preferably a complementary signal.

A plurality of semiconductor devices may be connected in series and the input signal may be serially transferred through all the semiconductor devices from a leading semiconductor device.

In the present invention, the digital operation unit has a signal determination unit for determining whether or not the destination of an input signal is a display driver having the digital operation unit concerned, based on a determination signal contained in the input signal. Therefore, the mechanism according to which the phase difference between the signals becomes the cause for erroneous operation can be in principle eliminated. As a result, the occurrence of video abnormality problem caused by the phase difference of the video data signal and clock signal can be in principle prevented.

Further, because the input signal to the digital operation unit is a complementary signal, the influence of ground potential bounce can be eliminated. The bounce of ground potential created by the operation of the drive unit is the in-phase noise generated at the same timing with all the signals in one semiconductor device (for example, a display driver). Therefore, use of the complementary signals as the input signal supplied to the digital operation unit makes it possible to eliminate in principle the influence of the in-phase noise.

As a consequence, the erroneous operation is reduced and reliability of data transfer is increased.

Therefore, quality increase and cost reduction of data transfer can be realized in a system (for example, a color PDP module) having a digital operation unit and a drive unit.

Further, in the present invention, the digital operation unit analyzes a control signal contained in the input signal and controls the associated drive unit based on the analysis results of the control signal. Therefore, highly reliable and low-cost data transfer can be realized.

These and other objects, aspects and advantages of the present invention will become apparent to those skilled in the art from the appended claims and following detailed description when read and understood in conjunction with the accompanying drawings.

### BRIEF DESCRIPTION OF THE DRAWINGS

FIG. 1 illustrates the configuration of a plasma display module which operates with a data transfer method of the first embodiment according to the present invention;

FIG. 2A illustrates the format of video signal data used in the first embodiment;

FIG. 2B illustrates another format of video signal data;

FIG. 3 is a block diagram of a display device of the first embodiment of the present invention;

FIG. 4A illustrates the format of video signal data used in the second embodiment;

FIG. 4B illustrates another format of video signal data;

FIG. 5 illustrates the configuration of a TFT liquid crystal display module which operates with the data transfer method of the fourth embodiment of the present invention;

FIG. 6 illustrates the configuration of a TFT organic EL display module which operates with the data transfer method of the fifth embodiment of the present invention; and

FIG. 7 is a block diagram of a conventional plasma display module.

### DETAILED DESCRIPTION OF THE INVENTION

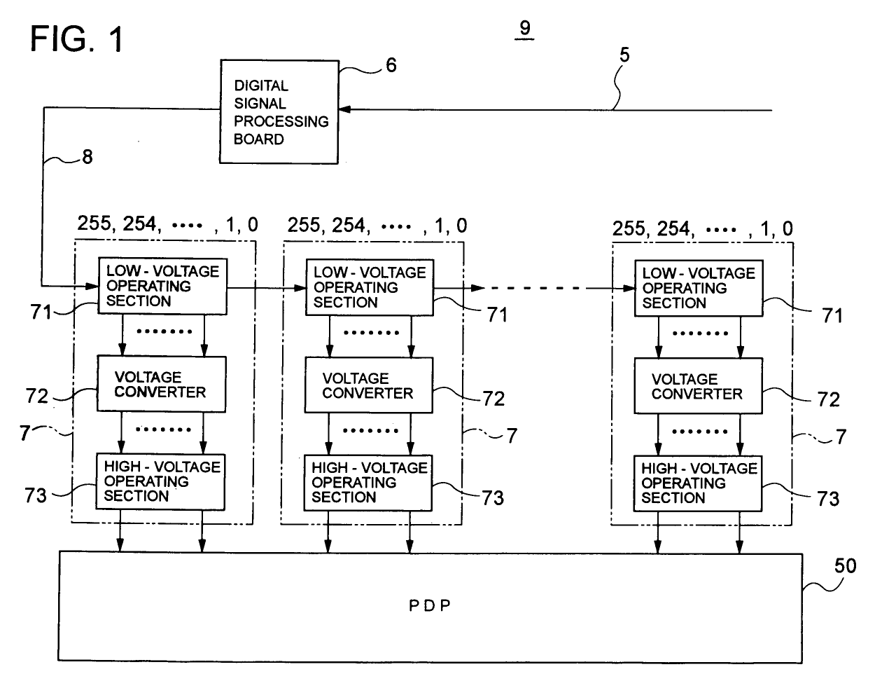

Embodiments of the present invention will be described hereinbelow with reference to FIG. 1 to FIG. 6 of the accompanying drawings.

### First Embodiment

The first embodiment of the present invention will be described with reference to FIG. 1 to FIG. 3. A W-XGA color PDP module will be described below as an example.

Referring to FIG. 1, the entire configuration of a PDP module (PDP module of W-XGA) 9 is described. The PDP module 9 employs the data transfer method of the first embodiment of the present invention.

As shown in FIG. 1, the PDP module 9 includes a digital signal processing board 6, a plurality (for example, 16) of data drivers (display drivers, semiconductor devices) 7, and a PDP (display unit) 50.

In this PDP module 9, signal processing such as subfield coding that is necessary for the PDP module 9 is implemented in the digital signal processing board 6 with respect to a video signal 5 supplied from the external unit (TV set or monitor), and then this video signal 5 is supplied via a data driver connection signal line 8 into a data driver (for example, a 256-bit data driver) 7. This video signal is a converted video signal, and also a signal to be supplied to a data driver interface.

Thus, a video data signal (input signal) transferred from the digital signal processing board 6 in synchronization with a transfer clock signal is introduced to the data driver 7.

The data driver 7, as described hereinbelow, includes a low-voltage operation unit (digital operation unit) 71 of a logical circuit with a comparatively low operation voltage, a voltage conversion unit 72 for converting a low-voltage signal into a high-voltage signal, and a high-voltage operation unit (drive unit) 73 with a comparatively high operation voltage for driving a PDP.

The data driver 7 includes a register, a level conversion circuit for converting (amplifying) the voltage, and a high-voltage output buffer. The video data signals introduced to the data driver 7 are held in the register of the data driver 7 and sent to the level conversion circuit in synchronization with a latch enable signal. All the signals sent to the data driver 7 are, for example, with an amplitude of 5.0 V. In the data driver 7, the section (including the register) up to the input stage of the level conversion circuit is a low-voltage operation unit 71 and processing in the low-voltage operation unit 71 is conducted at an amplitude of 5.0 V.

The level conversion circuit serves as a voltage conversion unit 72 to amplify the signal with an amplitude of 5.0 V to an amplitude of 70 V.

In the data driver 7, the section including and following the level conversion circuit (including the high-voltage output buffer) is a high-voltage operation unit 73. The high-voltage signal generated from the level conversion circuit is introduced to the PDP 50 via a high-voltage output buffer.

The data drivers 7 are connected in series to each other. Video signals from the digital signal processing board 6 are introduced into the data driver 7 (leading display driver, leading semiconductor device) at the leftmost end, as shown in FIG. 1, of the 16 data drivers 7 and are successively transferred to the remaining data drivers 7 till they reach the data driver 7 at the rightmost end. With such a transfer, data of one line is transferred for each subfield to the low-voltage operation units 71 of the data drivers 7.

The data driver 7 has an interface similar to that is described in the document titled “MOS Integrated Circuit μPD16373, 256/192 Bit Switching, AC-PDP driver, NEC Corporation., March, 2001,” and signals are supplied from the high-voltage operation unit 73 to the data terminals of the PDP 50 at the input timing of the latch enable signal (LE).

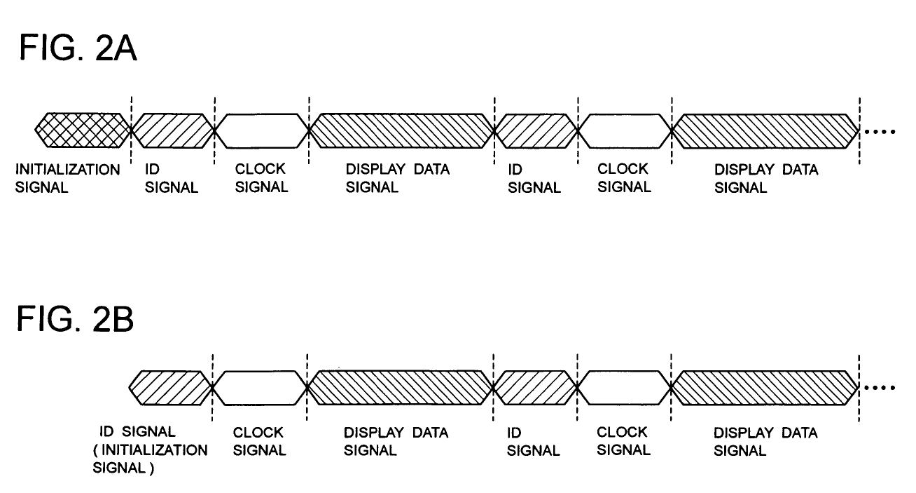

FIG. 2A shows the format of video signal data issued from the digital signal processing board 6 and introduced into the data driver 7 via the data driver connection signal line 8.

In the present embodiment, for example, as shown in FIG. 2A, the fundamental data format has “an initialization signal, an ID signal, a clock signal, and a display data signal” in this order and then has “an ID signal, a clock signal, and a display data signal” repeatedly.

The initialization signal is used only when the PDP module 9 is powered up from a deactivated condition.

The PDP module 9 usually has a function of conducting a priming discharge at least one time per one frame. Upon powering up of the PDP module 9, initialization setting is conducted by executing the priming discharge for the prescribed number of frames with a pulse of higher voltage or a pulse with a longer pulse width than the priming pulse for executing the usual priming discharge, as disclosed in Japanese Patent Kokai (Application Laid-open) No. 2000-20021.

In order to perform the initialization setting, the low-voltage operation unit 71 has an initialization setting unit for conducting the initialization setting of the PDP 50 when the initialization signal contained in the input signal is detected, and the initialization setting is conducted in the above-described manner with this initialization setting unit.

It should be noted that the initialization signal can be also contained in an ID signal, as shown in FIG. 2B. In this case, the low-voltage operation unit 71 conducts the initialization setting in the same manner as described above if the ID signal carrying the initialization signal is received.

The ID signal contains information indicating to which one of the data drivers 7 the video signal data is directed (i.e., destination of the video signal data).

The low-voltage operation unit 71 of the data driver 7 has a signal determination unit for detecting the ID signal contained in the input signal and determining, based on the detected ID signal, whether or not the destination of this input signal is the data driver 7 having the low-voltage operation unit 71 concerned.

When the signal determination unit of the low-voltage operation unit 71 determines that the destination of the input signal is the data driver 7 that has this low-voltage operation unit, the low-voltage operation unit 71 fetches the prescribed number of the display data contained in the input signal.

The low-voltage operation unit 71 transfers the fetched display data to the high-voltage operation unit 73 via the voltage conversion unit 72, to drive the high-voltage operation unit 73 according to the input signal and conduct the display operation on the PDP 50.

On the other hand, if the destination of the input signal is not the data driver 7 that has the low-voltage operation unit concerned, then the low-voltage operation unit 71 simply passes the input signal to the low-voltage operation unit 71 of the display drive 7 at the next stage.

Simply passing the input signal makes it possible to reduce power consumption. Because the voltage conversion unit 72 and high-voltage operation unit 73 do not operate at all, energy consumption can be reduced accordingly.

The clock signal is used for adjusting the synchronization to the prescribed accuracy since synchronization may be shifted if there is a phase difference, for example, a half-clock shift would occur. The low-voltage operation unit 71 also includes a synchronization unit for detecting the clock signal contained in the input signal and conducting synchronization with the clock signals.

It should be noted that the ID signal is a signal that has poorer synchronization accuracy than the clock signal, but is sufficient to attain synchronization. Accordingly, a synchronization signal (fetch timing signal) serving as a replacement of the clock signal may be contained in the ID signal. The synchronization unit detects this synchronization signal and conducts synchronization with the detected synchronization signal.

The display data signal of, for example, 256 bits (data capacity handled by one data driver 7) is fetched as one data transfer unit.

If one line takes, for example, 4096 dots, then one line data can be transferred by transferring 16 times the “ID signal+clock signal+display data signal”.

All the signals introduced to the data driver 7 (low-voltage circuit section thereof) via the data driver connection signal line 8 are the complementary signals composed of a logical YES signal (D) and a logical NOT signal (DB). The transfer protocol therefor is defined and the signals include a control signal and a display data signal.

The display data signals may be coded signals. In this case, the low-voltage operation unit 71 has a decoder unit for decoding the display data signal. The decoder unit decodes the display data signal and transfers it via the voltage conversion unit 72 to the high-voltage operation unit 73. Coding and transferring the display signals makes it possible to shorten the operation time of the low-voltage operation unit 71 and achieve further reduction of the power consumption.

In the example shown in FIG. 1 and FIG. 2A, initially, the digital signal processing board 6 transfers to each data driver 7 the initialization signals the very first time the color PDP module starts displaying, thereby setting each data driver 7 to an activation mode (initialization setting).

If the activation mode is set, an initialization priming pulse (for example, a pulse having a voltage higher than the usual priming pulse) is employed as the priming pulse for the prescribed number of subsequent fields. The usual mode is automatically assumed after the prescribed number of fields elapses.

Then, the clock signal and display data signal are transferred together with the ID signal (a signal specifying to which data driver of the 16 data drivers 7 the video signal is directed) of the data driver 7.

When the data driver 7 receives the ID signal corresponding to its own ID number that has been assigned in advance, it fetches the display data signal (video signal) with a period of the next arriving clock signal. The data driver 7 (for example, the leading data driver 7 (at the leftmost end)) completes fetching the video signals when it fetches the display data signal of 256 bits.

The digital signal processing board 6 transfers to another data driver 7 the ID number of this data driver 7 that should receive the video image next. The digital signal processing board 6 then transfers a clock signal and a display data signal to this data driver 7. As a result, fetching of the display data signal by the next data driver 7 (for example, a second data driver 7 from the left) is started.

This operation is repeatedly conducted till the video signals are transferred to all the data drivers 7. When the video signals are transferred to all the data drivers 7, e.g., when the fetching of video signals is completed in the 16th data driver 7, a special ID signal is transferred so that a latch enable operation is conducted in all the data drivers 7 and the video signals of one line are supplied from the data drivers 7 to the PDP 50. It should be noted that instead of the special ID signal, an ordinary ID signal may be used if the very last data driver 7 is known in advance.

Then, the digital signal processing board 6 transfers video signals of the second line, third line, . . . and the last line (i.e., the 768th line) successively to the data drivers 7 in a similar manner by conducting processing identical to the above-described processing except for the transfer of the initialization signal, to perform the display operation of one subfield.

The display operations for the next subfield and then the next subfield are also successively conducted by executing processing identical to the above-described processing except for the initialization setting.

As described hereinabove, high-speed, accurate data transfer with a low power consumption can be realized by adding a control signal to the input signal that is introduced in the data driver 7 and providing the data driver 7 with the function of dealing with this control signal. In other words, the above-described advantages can be achieved by including the ID signal, synchronization signal, and initialization signal as control signals into the input signal (video signal).

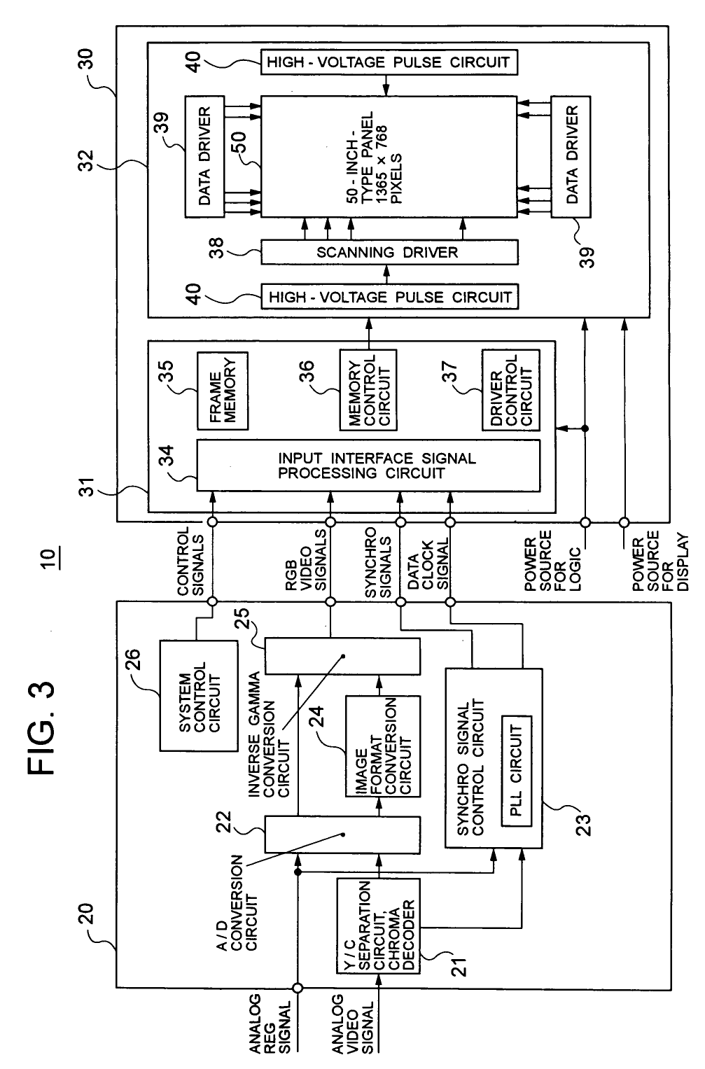

FIG. 3 is a block diagram of a plasma display device (flat display device) 10 of the present embodiment.

As shown in FIG. 3, the plasma display device 10 is designed to have a modular structure. More specifically, the plasma display device 10 includes an analog interface 20 and a plasma display panel module 30.

The analog interface 20 includes a Y/C separation circuit 21 having a chroma decoder, an A/D conversion circuit 22, a synchronization signal control circuit 23 having a PLL circuit, an image format conversion circuit 24, an inverse y (gamma) conversion circuit 25, and a system control circuit 26.

In brief, the analog interface 20 converts the received analog video signals into digital video signals and then supplies the digital video signals to a plasma display panel module 30.

For example, analog video signals generated by a TV tuner are decomposed into luminance signals of RGB colors in the Y/C separation circuit 21 and then converted into digital signals in the A/D conversion circuit 22.

When the pixel configuration of the plasma display panel module 30 is different from the pixel configuration of the video signal, necessary image format conversion is conducted in the image format conversion circuit 24.

The characteristic of display luminance is linearly proportional to the input signal of the plasma display panel, but the usual video signal is corrected (y conversion) in advance according to the CRT characteristic. Thus, the A/D conversion of video signals is conducted in the A/D conversion circuit 22 and then the inverse y conversion is implemented with respect to the video signals in the inverse y conversion circuit 25 so that a digital video signal restored to have a linear characteristic is generated. This digital video signal is supplied as the RGB video signal to the plasma display panel module 30.

Because the analog video signals do not contain a sampling clock signal and data clock signal for A/D conversion, the synchronization signal control circuit 23 generates the sampling clock and data clock signals based on the horizontal synchronization signal supplied simultaneously with the analog video signal and outputs them to the plasma display panel module 30.

The system control circuit 26 supplies control signals of each type to the plasma display panel module 30.

The plasma display panel module 30 includes a digital signal processing and controlling circuit 31 and a panel unit 32.

The digital signal processing and controlling circuit 31 includes an input interface signal processing circuit 34, a frame memory 35, a memory control circuit 36, and a driver control circuit 37.

The input interface signal processing circuit 34 receives control signals of various types generated from the system control circuit 26, RGB video signals generated from the inverse y conversion circuit 25, synchronization signals generated from the synchronization signal control circuit 23, and data clock signals generated from the PLL circuit.

The digital signal processing and controlling circuit 31 sends control signals to the panel unit 32 after the signals have been processed in the input interface signal processing circuit 34. At the same time, the memory control circuit 36 and driver control circuit 37 send a memory control signal and a driver control signal to the panel unit 32.

The panel unit 32 has a PDP 50, a scanning driver 38 for driving scanning electrodes, a data driver 39 (the data driver 39 is a general term including a plurality of data drivers 7) for driving data electrodes, and a high-voltage pulse circuit 40 for supplying a pulse voltage to the PDP 50 and scanning driver 38.

The PDP 50 is designed to have the pixels arranged as a 1365×768 matrix. In the PDP 50, the scanning driver 38 controls the scanning electrodes and the data driver 39 controls the data electrodes, thereby turning on and off the pixels to carry out the desired display.

In the first embodiment, a signal used as an input signal (video signal) to the data drivers 7 includes an ID signal that indicates which data driver of a plurality of data drivers 7 is the destination of the input signal. If it is determined that the data driver 7 which is currently receiving the input signal is the destination of the input signal, this data driver 7 is synchronization adjusted with a synchronization signal contained in the ID signal or clock signal following the ID signal. Therefore, the mechanism according to which the phase difference between the signals becomes the cause for erroneous operation can be in principle eliminated. As a result, the occurrence of video abnormality problem caused by the phase difference between the video data signal and clock signal can be in principle prevented.

Further, because the input signal to the low-voltage operation unit 71 of the data driver 7 is a complementary signal, the influence of ground potential bounce can be eliminated. The bounce of ground potential created by the operation of the high-voltage operation section 73 is the in-phase noise generated at the same timing with all the signals in one data driver 7. Therefore, use of the complementary signal as the input signal to the data driver 7 makes it possible to eliminate in principle the influence of the in-phase noise.

As a consequence, the erroneous operation is reduced and reliability of data transfer is increased.

Therefore, quality improvement and cost reduction with respect to data transfer can be realized in a color PDP module.

A remarkable recent progress in semiconductor technology enables the data transfer IF above 2 GHz in a 0.13 μm CMOS process. By using this technology and employing a configuration with a cascade connection of data drivers 7, as in the above-described embodiment, the following advantages can be obtained.

(1) The number of connection signal lines between the digital video signal processing board 6 and data driver 7 can be reduced.

(2) Employing the data transfer with a high-speed serial protocol and a complementary signal configuration greatly increases resistance to skew and high-voltage signal noise between video data, clock, and LE signals.

### Second Embodiment

The second embodiment is a modification to the first embodiment. FIG. 1 is also used for the second embodiment.

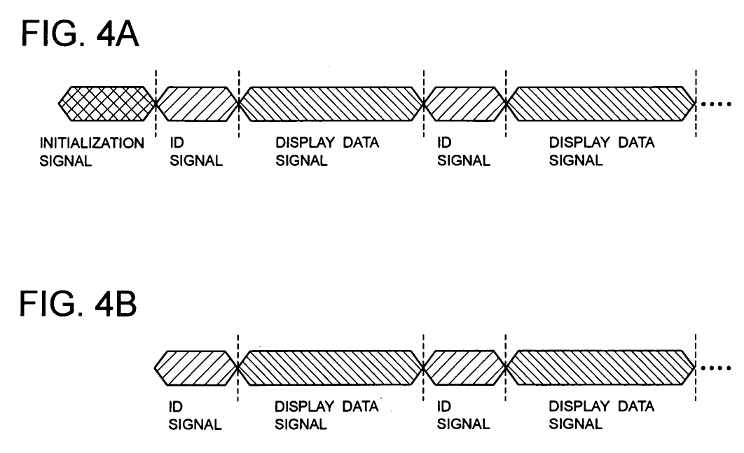

FIG. 4A shows the format of video signal data used in the second embodiment. This video signal data flows in the data driver connection signal line 8 shown in FIG. 1.

The signal shown in FIG. 4A is obtained by deleting the clock signal from the data format shown in FIG. 2A. FIG. 4B shows a signal obtained by deleting the clock signal from the data format shown in FIG. 2B.

In the first embodiment, the period of the clock signal can be decided by using a phase lock loop (PLL) circuit or delay lock loop (DLL) circuit. In the second embodiment, the period of the clock signal can be decided by using a free-running PLL or free-running DLL with the generation period fixed by the usual circuitry.

With the second embodiment, the transfer of the clock signal can be omitted by setting the clock signal period in advance into the data driver 7 and fetching the input signals in each data driver 7 at the clock frequency that is thus set.

Synchronization can be adjusted at the polarity reverse point of the display data signal or ID signal.

### Third Embodiment

The third embodiment is also a modification to the first embodiment.

In the third embodiment, when the display data for one data driver 7 are entirely black or entirely white, an entirely black or entirely white coded signal is transferred, instead of the display data, from the digital signal processing board 6 to the data driver 7.

In this embodiment, the low-voltage operation unit 71 has a decoder unit for decoding the coded signal and converting it into display data.

With the third embodiment, an entirely black or entirely white coded signal is transferred instead of the display data when the display data for a certain data driver 7 is entirely black or entirely white. Therefore, the operation time of the low-voltage operation unit 71 can be shortened, if compared with a case where the entire 256-bit data is received. Thus, the third embodiment can reduce power consumption.

When the decoded display data is entirely black, a signal indicating that the data is entirely black is sent from the low-voltage operation unit 71 to the high-voltage operation unit 73. On the other hand, when the decoded display data is entirely white, a signal indicating that the data is entirely white is sent from the low-voltage operation unit 71 to the high-voltage operation unit 73. Thus, the consumed power of the voltage conversion unit 72 can also be suppressed.

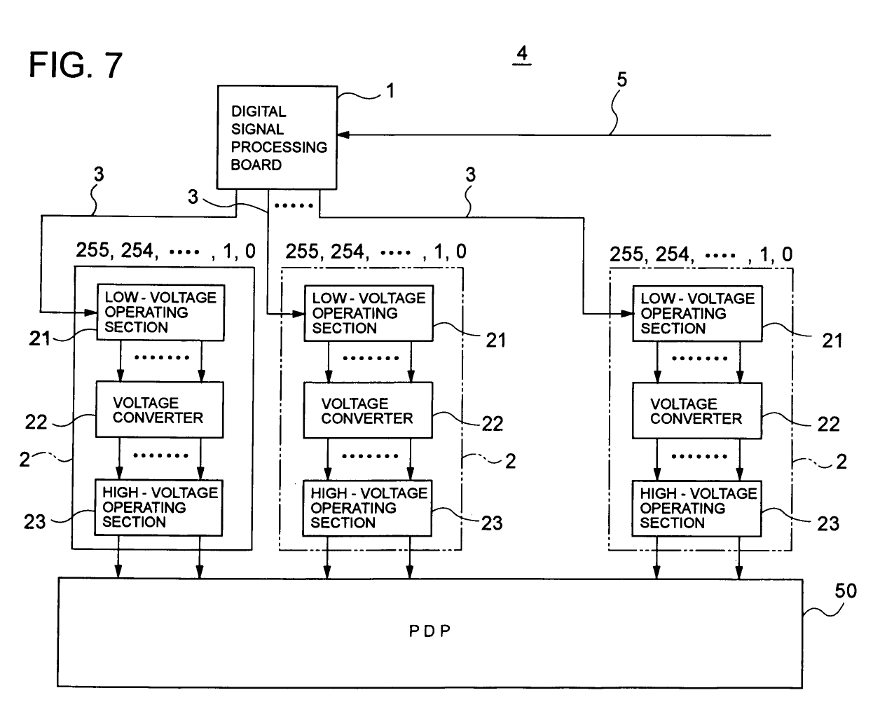

In the above-described three embodiments, the data drivers 7 are connected in series and the input signal is transferred serially through the data drivers 7, but the present invention is not limited to such configurations. For example, the data drivers 7 may be connected in parallel as shown in FIG. 7, and the input signal (FIG. 2A, 2B, 4A or 4B) may be supplied to the respective data drivers 7.

### Fourth Embodiment

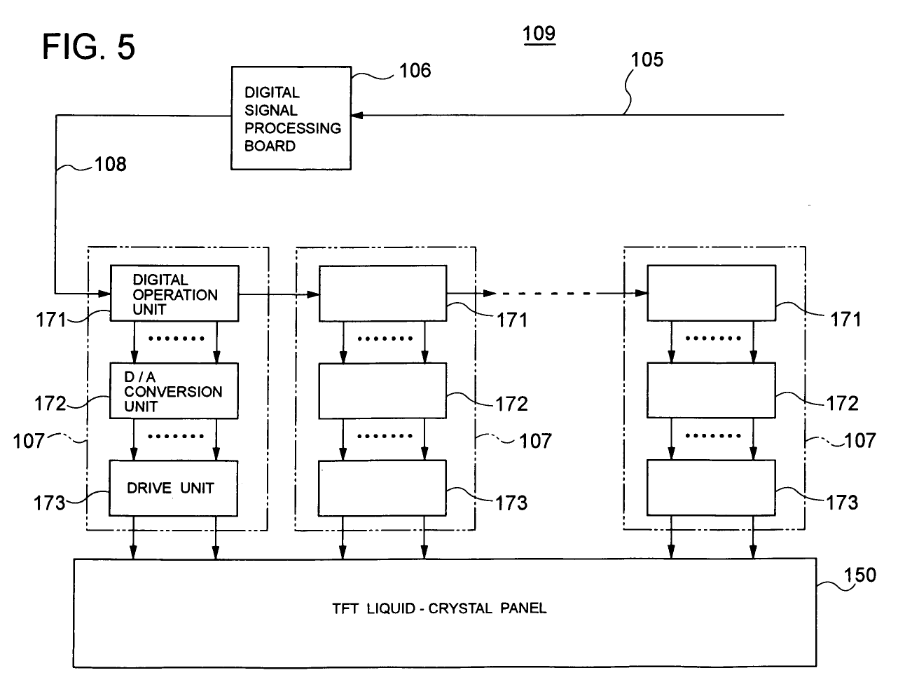

Referring to FIG. 5, the fourth embodiment of the present invention will be described by an example of a liquid-crystal display module. A W-XGA liquid-crystal display module is described here.

As shown in FIG. 5, the liquid-crystal display module 109 of the fourth embodiment includes a digital signal processing board 106, a plurality of data drivers (display drivers, semiconductor devices) 107, and a liquid-crystal panel (display unit) 150.

A video signal 105 is introduced from the outside to the digital signal processing board 106.

In the video signal 105, a signal of one pixel is composed of R, G, B signals, and each of R, G, B video signals is supplied in parallel into the digital signal processing board 106.

In the digital signal processing board 106, the input video signals are rearranged in the order of the following pixel sequence; the first pixel of R, first pixel of G, first pixel of B, second pixel of R, second pixel of G, second pixel of B, . . . .

Unlike the PDP, the liquid crystal display does not use a subfield method for a multi-grayscale display.

The liquid crystal display realizes the multi-grayscale (gradation) display by changing the voltage applied to the liquid crystals. In order to achieve a 256-gradation display, one pixel is displayed by 8-bit R data, 8-bit G data and 8-bit B data.

Therefore, the video data signal generated from the digital signal processing board 106 is introduced into the data driver 107 via a data driver connection signal line 108 as the converted video signals to be introduced into the data driver interface in the pixel sequence as follows: 8-bit video signal of the first pixel of R, 8-bit video signal of the first pixel of G, 8-bit video signal of the first pixel of B, 8-bit video signal of the second pixel of R, . . .

Thus, the video data signals (input signals) transferred from the digital signal processing board 106 in synchronization with the transfer clock signal are introduced into the data driver 107.

The data driver 107 includes, as described hereinbelow, a digital operation unit 171 of a logical circuit with a comparatively low operation voltage, a D/A conversion unit 172 for converting digital signals into analog signals, and a driver unit 173 for driving the TFT liquid-crystal panel 150.

The video data signal supplied into the data driver 107 is stored in the register of the data driver 107 and sent to the D/A conversion unit in synchronization with the input of the latch enable signal. Like the first embodiment, all the signals introduced into the data driver 107 have, for example, an amplitude of 5.0 V. In the data driver 107, the section up to the input to the D/A conversion unit is a digital operation unit 171 operating at a low voltage. In this digital operation unit 171, processing is conducted at an amplitude of 5.0 V.

The D/A conversion unit 172 converts the 8-bit digital signal of 256-gradation with an amplitude of 5.0 V to an analog signal of, for example, 0-12 V. The analog signal generated from the D/A conversion unit 172 is supplied to the TFT liquid-crystal panel 150 via the drive unit 173. The drive unit 173 serves as both a buffer circuit and an output controller. The transmittance of the liquid crystal is controlled by the voltage of the signal generated from the driver unit 173 and a display faithful to the input video signal is realized.

The data drivers 107 are connected in series, in the same manner as in the first embodiment.

The configuration of the digital operation unit 171 is similar to the low-voltage operation section 71 (FIG. 1) of the first embodiment and description of the structure of the digital operation unit 171 is, therefore, omitted. The operation of the digital operation unit 171 is also similar to that described with reference to FIG. 2A in the first embodiment so that description of the operation of the digital operation unit 171 is omitted. However, the TFT liquid-crystal panel does not require the initialization setting, unlike the PDP. Therefore, the initialization signal shown in FIG. 2A can be omitted.

Similar to the first embodiment, the ID signal contains information indicating a target (destination) data driver 107, of a plurality of data drivers 107, to which the video signal is directed. The digital operation unit 171 of the data driver 107 has a signal determination unit that detects the ID signal contained in the input signal and determines, based on the detected ID signal, whether or not the destination of this input signal is the data driver 107 having this digital operation unit 171.

When the destination of the input signal is determined to be the data driver 107 in use, the digital operation unit 171 of this data driver 107 fetches the prescribed number of display data contained in the input signal.

Then, the digital operation unit 171 transfers the fetched display data to the driver unit 173 via the D/A conversion unit 172, applies the analog voltage to the TFT liquid-crystal panel 150 in accordance with the input signal, and causes the TFT liquid-crystal panel 150 to conduct the display operation.

On the other hand, when the destination of the input signal is not the data driver 107 having this digital operation unit 171, this digital operation unit 171 passes the input signal to the low-voltage operation unit 171 of the display driver 107 of the next stage.

The low-voltage operation unit 171 also includes a synchronization unit for detecting the clock signal contained in the input signal and conducting synchronization with this clock signal.

Unlike the first embodiment, the display data signal becomes gradation (multi-grayscale) data. Data of a display element of a certain color, that is, one element of any color of R, G, B, is 8-bit data if 256 gradations should be created. Accordingly, if the 256-element display data is one data transfer unit, then 8×256 bits (data capacity distributed by one data driver 107) is one data transfer unit.

All the signals supplied into the data driver 107 via the data driver connection signal line 108 are complementary signals composed of a logical YES signal (D) and logical NOT signal (DB) and the transfer protocol therefor is defined. The signal includes a control signal and a display data signal.

As described above, in the fourth embodiment, by adding a control signal to the input signal that is supplied into the data driver 107 and providing the data driver 107 with a function of dealing with this control signal, it is possible to realize high-speed, accurate data transfer with a low power consumption. Thus, the above-described advantages can be demonstrated by including an ID signal, synchronization signal, and initialization signal as control signals in the video signal.

### Fifth Embodiment

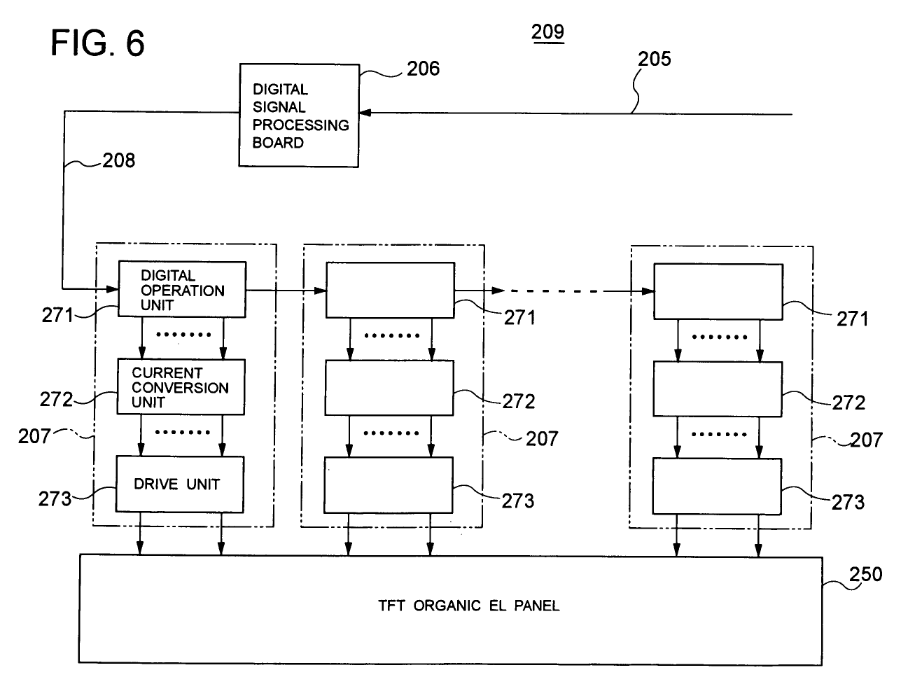

The fifth embodiment will be described with reference to FIG. 6 by an example of a TFT organic electroluminescent (EL) display module. Organic EL displays can be voltage driven or current driven. In the case of voltage drive, the configuration becomes similar to that of the fourth embodiment. Thus, the fifth embodiment deals with current drive. Similar to the configuration shown in FIG. 1, a W-XGA organic EL display module will be described below.

As shown in FIG. 6, a TFT organic EL liquid-crystal display module 209 includes a digital signal processing board 206 for receiving a video signal 205, a plurality of data drivers 207 for receiving the processed video signal from the digital signal processing board 206 via a data driver connection signal line 208, and a TFT organic EL panel (display unit) 250 driven by these data drivers 207.

Each data driver 207 includes a digital operation unit 272, a current conversion unit 272, and a drive unit 273.

The fifth embodiment is a modification to the fourth embodiment. Specifically, the only difference between the fifth embodiment (FIG. 6) and fourth embodiment (FIG. 5) lies in that the D/A conversion unit 172 in FIG. 5 is replaced by the current conversion unit 272. The operation of the display module 209 is the same as that of the display module 109 so that the description of the display module 209 is omitted.

The advantages achievable in the fifth embodiment are identical to that of the first and fourth embodiments.

As described above, the data transfer method in accordance with the present invention can applied to flat displays such as plasma display devices, liquid-crystal display devices, and organic electroluminescence display devices. However, application of the present invention is not limited to those mentioned above. For example, the present invention can also be employed in systems for high-speed data transfer over large-scale physical spaces in an apparatus including semiconductor devices equipped with operation units (low-voltage operation unit and high-voltage operation unit) operating at two or more different operation voltages or systems in which power source and ground bounce caused by high-voltage operation adversely affect the operation.

This application is based on a Japanese Patent Application No. 2004-118731 filed on Apr. 14, 2004 and the entire disclosure thereof is incorporated herein by reference.

What is claimed is:

1. A display device comprising a display unit and a plurality of display drivers, wherein
each said display driver has a digital operation unit and a drive unit, and
each said digital operation unit of each said display driver has a signal determination unit for determining whether or not a destination of an input signal is the display driver which is currently receiving said input signal, based on a determination signal contained in said input signal.

2. The display device according to claim 1, wherein each said digital operation unit further has a synchronization unit for conducting synchronization with a clock signal or said determination signal contained in said input signal.

3. The display device according to claim 1, wherein said input signal contains a display data signal, and
when said determination unit determines that the destination of said input signal is the display driver which is currently receiving said input signal, the display driver concerned fetches the display data signal contained in the input signal.

4. The display device according to claim 3, wherein said display data signal is a coded data signal, and said digital operation unit further has a decoder unit for decoding said display data signal.

5. The display device according to claim 1, wherein when said determination unit determines that the destination of said input signal is the display driver which is currently receiving said input signal, the display driver concerned fetches the input signal.

6. The display device according to claim 1, wherein each said digital operation unit has an initialization setting unit for performing initialization setting of said display unit when an initialization signal is detected in said input signal.

7. The display device according to claim 1, wherein said plurality of display drivers are connected in series with each other, and said input signal is serially transferred through said plurality of display drivers.

8. The display device according to claim 1, wherein said plurality of display drivers are connected in parallel with each other, and said input signal is supplied to each of said plurality of display drivers.

9. The display device according to claim 1, wherein said input signal is a complementary signal.

10. A display device comprising a display unit and a plurality of display drivers, wherein each said display driver has a digital operation unit and a drive unit, and each said digital operation unit analyzes a control signal contained in an input signal and controls the drive unit associated with the digital operation unit concerned, in accordance with analysis results of said control signal.

11. The display device according to claim 10, wherein said control signal is a determination signal, and said digital operation unit concerned determines whether or not a destination of the input signal containing said determination signal is the display driver having said digital operation unit concerned, in accordance with the analysis results of said determination signal.

12. The display device according to claim 10, wherein said control signal is a synchronization signal, and each said digital operation unit analyzes said synchronization signal and conducts synchronization with said synchronization signal.

13. The display device according to claim 10, wherein said control signal is a coded display data signal, and each said digital operation unit controls the associated drive unit in accordance with the analysis results of said display data signal.

14. The display device according to claim 10, wherein said control signal is an initialization signal, and each said digital operation unit conducts initialization setting of said display unit in accordance with analysis results of said initialization signal.

15. The display device according to claim 10, wherein said plurality of display drivers are connected in series with each other, and said input signal is serially transferred through said plurality of display drivers.

16. The display device according to claim 10, wherein said plurality of display drivers are connected in parallel with each other, and said input signal is supplied to each of said plurality of display drivers.

17. The display device according to claim 10, wherein said input signal is a complementary signal.

18. A display driver comprising a digital operation unit and a drive unit for driving a display panel with said drive unit in accordance with an input signal, wherein said digital operation unit has a signal determination unit for determining whether or not a destination of said input signal is said display driver based on a determination signal contained in said input signal.

19. A display driver comprising a digital operation unit and a drive unit for driving a display panel with said drive unit in accordance with an input signal, wherein said digital operation unit analyzes a control signal contained in the input signal, and controls the drive unit based on analysis results of the control signal.

20. A data transfer method for transferring data to a semiconductor device, said semiconductor device including a digital operation unit and a drive unit, said data transfer method comprising:
supplying to said digital operation unit an input signal containing a determination signal used for determining whether or not a destination of said input signal is said semiconductor device; and
introducing a signal generated from said digital operation unit into said drive unit.

21. The data transfer method according to claim 20, wherein the input signal supplied to said digital operation unit is a complementary signal.

22. The data transfer method according to claim 20, wherein there is provided a plurality of said semiconductor devices which are connected in series with each other, and said input signal is serially transferred through said plurality of semiconductor devices.

23. A data transfer method for transferring data to a semiconductor device for driving a display panel with a drive unit based on an input signal, said semiconductor device having a digital operation unit and said drive unit, said data transfer method comprising:
supplying to said digital operation unit said input signal containing a determination signal used for determining whether or not a destination of said input signal is said semiconductor device; and
supplying display data to be displayed on said display panel into said digital operation unit.

24. The data transfer method according to claim 23, further comprising supplying to said digital operation unit a fetch timing signal specifying a timing for said digital operation unit to fetch said display data.

25. The data transfer method according to claim 23, wherein the input signal introduced into said digital operation unit is a complementary signal.

26. The data transfer method according to claim 23, wherein there is provided a plurality of said semiconductor devices which are connected in series with each other, and said input signal is serially transferred through said plurality of semiconductor devices.
